(19) United States
(12) Patent Application Publication
(10) Pub. No.: US 2026/0192745 A1
(43) Pub. Date: Jul. 9, 2026

(54) LIGHT EMITTING MODULE FOR VEHICLES

(71) Applicant: Seoul Semiconductor Co., Ltd., Ansan-si (KR)

(72) Inventor: Inheum PARK, Ansan-si (KR)

(21) Appl. No.: 19/435,783

(22) Filed: Dec. 30, 2025

Related U.S. Application Data
(60) Provisional application No. 63/742,440, filed on Jan. 7, 2025.

(51) Int. Cl. B60Q 3/233

(52) U.S. Cl. CPC B60Q 3/233

(57) ABSTRACT

A light emitting module for vehicles includes a substrate and a plurality of light sources disposed on the substrate, in which a peak wavelength of emission light emitted from at least one of the plurality of light sources is in a range of 620 nm to 670 nm.

### CROSS REFERENCE TO RELATED APPLICATION

This application claims priority from and the benefit of U.S. Provisional Application No. 63/742,440, filed on January 7, 2025, which is hereby incorporated by reference for all purposes as if fully set forth herein.

### BACKGROUND

### FIELD

Embodiments of the invention relate generally to a light emitting module for vehicles, and more particularly, to a light emitting module for vehicles that can be installed inside a vehicle and irradiates light toward an occupant of the vehicle.

### DISCUSSION OF THE BACKGROUND

Recently, nitride semiconductors have been widely used as base material for light emitting devices such as light emitting diodes. The nitride semiconductors can have various band gap energies depending on a composition ratio of group III elements, thus light of various wavelengths can be realized by controlling the composition ratio of elements such as Al, Ga, In, or others.

A multi quantum well structure (MQW) may be used as an active layer structure, and an emission wavelength of a light emitting device is determined by a composition ratio of a nitride semiconductor in a well layer of the multi quantum well structure.

Lighting apparatuses employing the light emitting diodes have achieved sufficient brightness through the development of watt-level light emitting diodes for lighting. Recently, such lighting apparatuses have been developed for use not only in household applications but also in industrial and automotive applications, and it is expected that the light emitting diodes will be adopted in an increasing number lighting apparatuses in the future.

The above information disclosed in this Background section is only for understanding of the background of the inventive concepts, and, therefore, it may contain information that does not constitute prior art.

### SUMMARY

Embodiments of the invention may provide a light emitting module for vehicles that irradiates light toward an occupant riding in a vehicle.

Embodiments of the invention may also provide a light emitting module for vehicles that irradiates light having a wavelength range associated with promoting hair growth to a scalp of an occupant riding in a vehicle.

Embodiments of the invention may provide a light emitting module for vehicles with improved reliability.

Additional features of the inventive concepts will be set forth in the description which follows, and in part will be apparent from the description, or may be learned by practice of the inventive concepts.

A light emitting module for vehicles according to an embodiment of the invention may include a substrate and a plurality of light sources disposed on the substrate, in which a peak wavelength of emission light emitted from at least one of the plurality of light sources may be in a range of 620 nm to 670 nm.

The light emitting module may be installed on an upper side of a seat in a vehicle.

A luminous intensity spectrum of emission light emitted from at least one of the plurality of light sources may be different from that of emission light emitted from another one of the plurality of light sources.

A luminous intensity spectrum of emission light emitted from the light emitting module may have at least one peak in a wavelength range of 380 nm to 480 nm.

A luminous intensity spectrum of emission light emitted from the light emitting module may have at least one valley in the wavelength range of 380 nm to 480 nm.

In a luminous intensity spectrum of emission light emitted from the light emitting module, a peak luminous intensity in the wavelength range of 380 nm to 480 nm may be 0.4 times or less of a peak luminous intensity in the wavelength range of 620 nm to 670 nm.

In a luminous intensity spectrum of emission light emitted from the light emitting module, a luminous intensity in the wavelength range of 380 nm to 480 nm may be 25% or less of a total luminous intensity.

In a luminous intensity spectrum of emission light emitted from the light emitting module, a luminous intensity in the wavelength range of 620 nm to 670 is 20% or less of the total luminous intensity.

In a luminous intensity spectrum of emission light emitted from the light emitting module, a luminous intensity in the wavelength range of 620 nm to 670 nm may be less than a luminous intensity in the wavelength range of 380 nm to 480 nm.

A luminous intensity spectrum of emission light emitted from the light emitting module may have at least one peak in a wavelength range of 480 nm to 620 nm.

A maximum peak luminous intensity in the wavelength range of 480 nm to 620 nm may be less than a maximum peak luminous intensity in the wavelength range of 380 nm to 480 nm.

The plurality of light sources may include a first light source having a peak luminous intensity in the range of 620 nm to 670 nm and a second light source having a peak luminous intensity in the range of 380 nm to 480 nm.

A total luminous intensity of emission light emitted from the second light source may be greater than that of emission light emitted from the first light source.

The total luminous intensity of emission light emitted from the second light source may be three times or more of that of emission light emitted from the first light source.

At least a portion of a luminous intensity spectrum of emission light emitted from the second light source may overlap with a luminous intensity of emission light emitted from the first light source.

A light emitting module according to another embodiment of the invention includes a substrate and a plurality of light sources disposed on the substrate, the plurality of light sources may include a first light source configured to emit light having a peak wavelength in a range of 620 nm to 670 nm and a second light source configured to emit light having a plurality of peak wavelengths in a wavelength range of 380 nm to 730 nm.

The light emitting module may further include a lens for adjusting an optical path of emission light emitted from at least one of the plurality of the light sources.

The lens may include curved regions having different curvatures for each region on a light exiting surface.

The light exiting surface of the lens may include a first curved region forming a first light-irradiation area and a second curved region forming a second light-irradiation area wider than the first light-irradiation area and having a radius of curvature larger than that of the first curved region.

The second light source may include a plurality of light emitting diodes having a peak wavelength different from that of the first light source, the light emitting module further comprise a controller configured to control light quantity ratios of the plurality of light emitting diodes so that a luminous intensity spectrum of emission light emitted from the second light source is similar to that of sunlight.

It is to be understood that both the foregoing general description and the following detailed description are exemplary and explanatory and are intended to provide further explanation of the invention as claimed.

### BRIEF DESCRIPTION OF THE DRAWINGS

FIGS. 1A and 1B are schematic diagrams showing a light-irradiation area irradiated by a light emitting module for vehicles installed in a vehicle according to an embodiment.

FIG. 2 is a plan view showing a roof of the vehicle from inside the vehicle of FIG. 1A.

FIG. 3 is a side view showing the light emitting module for vehicles that irradiates light onto a scalp of a vehicle occupant of FIG. 2 according to an embodiment.

FIG. 4 is a modified example of FIG. 3 according to another embodiment.

FIG. 5 is a graph illustrating a luminous intensity spectrum of emission light emitted from a light emitting module for vehicles according to an embodiment of the invention.

FIG. 6 is a graph showing a luminous intensity spectrum of emission light emitted from a light emitting module for vehicles according to another embodiment of the invention.

FIG. 7 is a graph illustrating a luminous intensity spectrum of emission light emitted from a light emitting module for vehicles according to another embodiment of the invention.

FIG. 8 is a cross-sectional side view showing a light emitting device of the light emitting module for vehicles of FIG. 6.

FIG. 9 is a plan view showing a light emitting module for vehicles according to another embodiment of the invention.

FIG. 10 is a graph illustrating color coordinate regions of natural light by time zone from sunrise to sunset.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z – axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

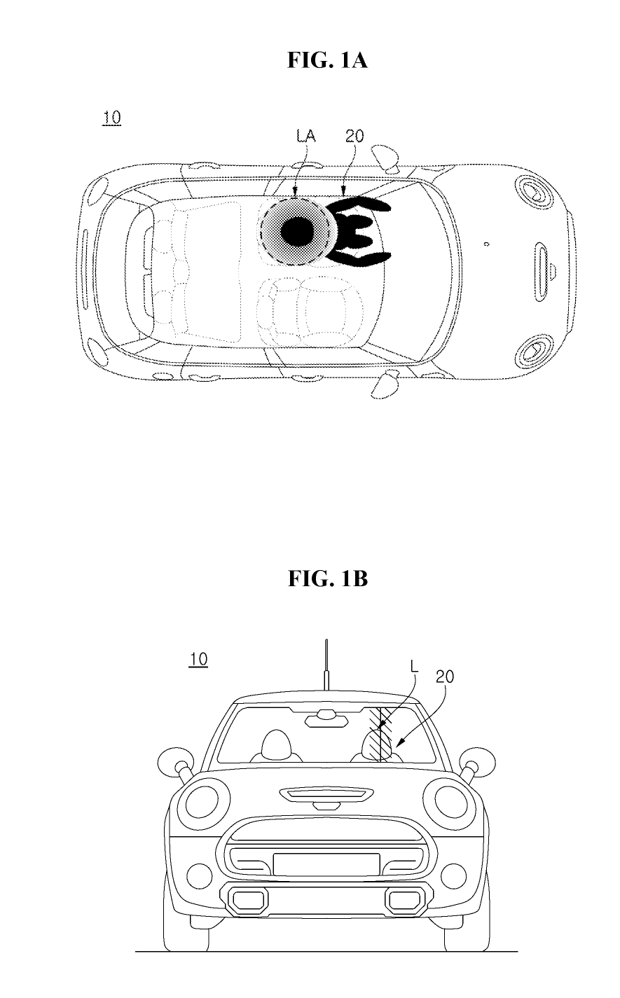

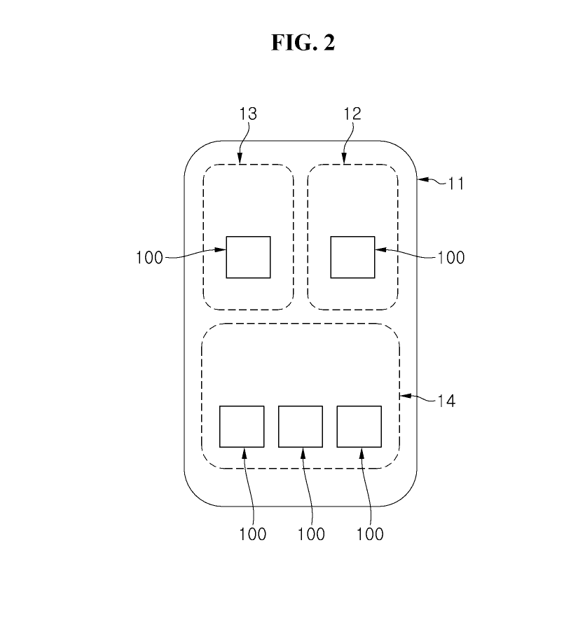

Referring to FIGS. 1A through 3, a light emitting module for vehicles according to an embodiment of the invention may be installed in a vehicle 10 and irradiate light L inside the vehicle 10. Light L emitted from the light emitting module for vehicles may form a light-irradiation area LA in a region where a scalp 21 of an occupant 20 riding in the vehicle 10 is positioned. The light emitting module for vehicles may include a lighting device installed inside the vehicle 10, and may be installed on an upper interior of the vehicle 10 to irradiate light L in a downward direction.

FIG. 1A and FIG. 1B exemplarily illustrate that light L emitted from the light emitting module for vehicles is irradiated onto a driver's seat of the vehicle 10, but the inventive concepts are not limited thereto. In some embodiment, the light L may also be irradiated onto another seat of the vehicle, such as a passenger seat.

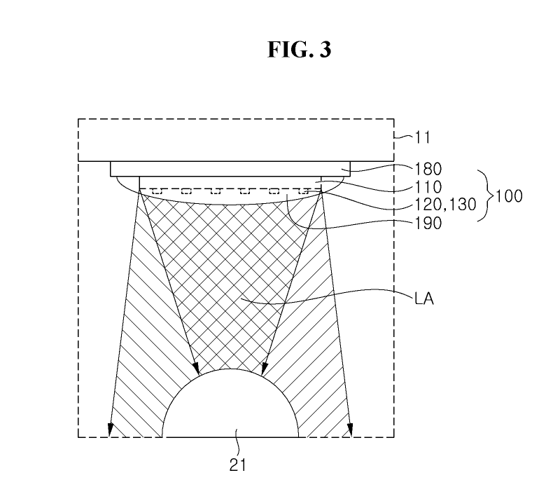

FIG. 2 illustrates a light emitting module 100 for vehicles according to an embodiment of the invention, and the light emitting module 100 for vehicles may be installed on an upper side of the vehicle 10, for example, on a roof surface 11. The light emitting module 100 for vehicles may be installed on an upper side of a seat in the vehicle 10.

The light emitting module 100 for vehicles may be installed in various positions on the roof surface 11 of the vehicle 10. For example, the light emitting module 100 for vehicles may be installed in at least one of an upper region of a driver's seat 13, an upper region of a passenger seat 12, and an upper region of a back seat 14 of the roof surface 11. Since multiple occupants 20 may ride in the back seat 14, the light emitting module 100 for vehicles may be installed in a number corresponding to a maximum number of occupants 20 that may ride in the back seat 14.

Referring to FIG. 3, the light emitting module 100 for vehicles may include a substrate 110 and a plurality of light sources 120 and 130 disposed on the substrate 110.

The substrate 110 may be a base substrate on which the plurality of light sources 120 and 130 is disposed. The substrate 110 may be provided with interconnections for supplying power to the plurality of light sources 120 and 130 and controlling operations of the plurality of light sources 120 and 130. The substrate 110 may be formed into various shapes. FIG. 3 exemplarily illustrates that the substrate 110 is formed in a rectangular shape, but the inventive concepts are not limited to a particular shape of the substrate 110.

The light sources 120 and 130 may include at least one light emitting diode. The light emitting diode may include a first conductivity type semiconductor layer, an active layer, and a second conductivity type semiconductor layer.

The first conductivity type semiconductor layer may be a semiconductor layer grown on one surface of a growth substrate. The first conductivity type semiconductor layer may include a nitride semiconductor such as (Al, Ga, In)N, and may be formed by being grown on the growth substrate using a method such as MOCVD, MBE, HVPE, or the like. In addition, the first conductivity type semiconductor layer may be doped as n-type by including one or more impurities such as Si, C, Ge, Sn, Te, Pb, or others. However, without being limited thereto, the first conductivity type semiconductor layer may be doped with an opposite conductivity type, including a p-type dopant in other embodiments.

The active layer may have a multi quantum well structure (MQW) as a light emitting layer formed over the first conductivity type semiconductor layer. The active layer may include a nitride semiconductor such as (Al, Ga, In)N, and may be grown on the first conductivity type semiconductor layer using a technique such as MOCVD, MBE, HVPE, or the like.

A wavelength of light emitted from the active layer may be adjusted by controlling a composition ratio of a nitride semiconductor layer of a well layer. In this case, the well layer may include a nitride semiconductor including In.

The second conductivity type semiconductor layer may be a semiconductor layer formed on the active layer. The second conductivity type semiconductor layer may include a nitride semiconductor such as (Al, Ga, In)N, and may be grown using a technique such as MOCVD, MBE, HVPE, or the like.

The second conductivity type semiconductor layer may be doped with a conductivity type opposite to that of the first conductivity type semiconductor layer. For example, the second conductivity type semiconductor layer may be doped as p-type by including an impurity such as Mg.

A structure of the light emitting diode may be configured in various ways, and thus, light emitting diodes of various structures may be implemented. For example, the light emitting diode may be formed into various structures, such as a flip-chip type, vertical type, or others.

The light emitting diode may emit light having a single peak wavelength, or may emit light having multi peak wavelengths.

Each of the light sources 120 and 130 may include a single light emitting diode or may include a plurality of light emitting diodes. The light emitting diode may be mounted on the substrate 110 or may be disposed on the substrate 110 while being mounted on another substrate.

In a case that the light sources 120 and 130 include the plurality of light emitting diodes, the plurality of light emitting diodes may emit light having a same peak wavelength. Alternatively, at least one of the plurality of light emitting diodes may emit light having a peak wavelength different from that of other light emitting diodes.

The light emitting module 100 may emit, as emission light, mixed light formed by light emitted from each of the light sources 120 and 130. The plurality of light sources 120 and 130 may be driven independently of one another. Alternatively, at least portions of the plurality of light sources 120 and 130 may be grouped and driven together.

In addition, the light emitting module 100 for vehicles may further include a main body 180 to be installed within the vehicle 10. For example, the main body 180 may be securely installed on the roof surface 11 of the vehicle 10, and may support the light emitting module 100 for vehicles such that the light emitting module 100 for vehicles is stably and securely installed.

In addition, the light emitting module 100 for vehicles may further include a lens 190 for adjusting an optical path of emission light. The emission light may be focused or diverged while passing through the lens 190, thereby forming the light-irradiation area LA. The light-irradiation area LA may be varied depending on a light irradiation mode of the light emitting module 100. The light irradiation mode may include a plurality of operation modes. For example, the light irradiation mode may include a therapy light irradiation mode that irradiates light to a light-irradiation area LA limited to a scalp 21 of the occupant 20, and a lighting mode that irradiates light to a wide light-irradiation area LA to brighten an environment inside the vehicle 10 and ensure visibility for the occupant 20.

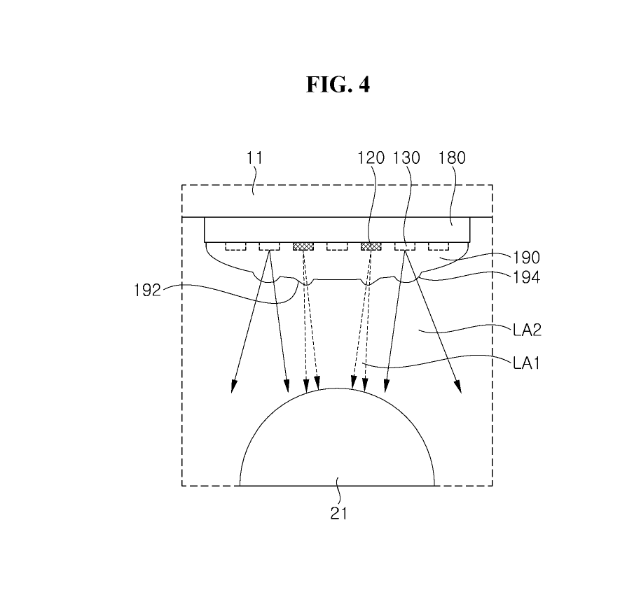

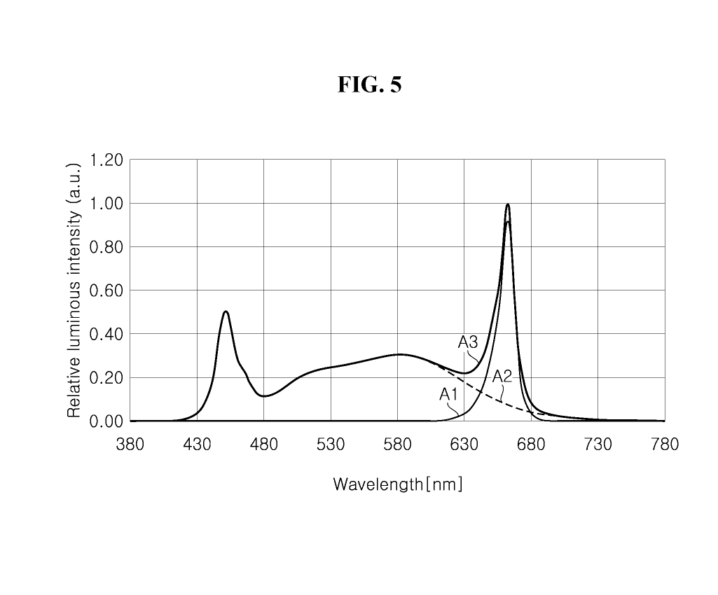

FIG. 4 illustrates a modified example of the lens 190 of FIG. 3 according to another embodiment. Referring to FIG. 4, the lens 190 may include curved regions having different curvatures for each region so as to vary the light-irradiation area LA. For example, a first curved region 192 forming a first light-irradiation area LA1 limited to the scalp 21 among light exiting surfaces of the lens 190 may have a radius of curvature smaller than other regions. In addition, the first curved region 192 may have a radius of curvature of one region smaller than a radius of curvature of the other region. In addition, the first curved region 192 may have an asymmetrical shape. For example, the radius of curvature of the first curved region 192 may decrease towards a center of the lens 190. In addition, the radius of curvature of the first curved region 192 may increase towards an outer edge of the lens 190. In this manner, light may be focused onto a specific region. In addition, a second curved region 194 forming a second light-irradiation area LA2 wider than the first light-irradiation area LA1 among the light exiting surfaces of the lens 190 may have a radius of curvature larger than that of the first curved region 192. Accordingly, a design difficulty of an apparatus for differently adjusting the light-irradiation area LA may be reduced. In addition, the first curved region 192 may be positioned inside the second curved region 194. The first curved region 192 may be disposed in a region corresponding to the first light source 120. Also, the second curved region 194 may be disposed in a region corresponding to the second light source 130. Light emitted from the first light source 120 may be mainly irradiated through the first light-irradiation area LA1. In addition, light emitted from the second light source 130 may be mainly irradiated through the second light-irradiation area LA2. A therapeutic effect may be efficiently increased by differentiating the light-irradiation area LA for each of the light sources 120 and 130.

Hereinafter, luminous intensity spectra of emission light emitted from the light emitting module 100 for vehicles will be described in detail with reference to FIGS. 5 through 7.

When emission light of the light emitting module 100 for vehicles is irradiated onto a human body, it may be transmitted to various depths in the human tissue and absorbed into the cell to act depending on a wavelength range. For example, depending on the wavelength range of emission light, it may have therapeutic effects such as promoting blood circulation in the human body or activating cells. These effects may vary depending on various factors such as a wavelength, irradiation amount, intensity, and light irradiation method of emission light onto the human body, and these need to be appropriately adjusted depending on a purpose of irradiation on the human. Although penetration depth may vary somewhat depending on a type of tissue, generally, light with a wavelength of 400 nm has a penetration depth of less than 1 mm in the human tissue, light with a wavelength of 514 nm has a penetration depth of0.5 mm to 2 mm in the human tissue, light with a wavelength of 630 nm has a penetration depth of 1 mm to 6 mm, and light with a wavelength of 700 nm to 900 nm has a greater penetration depth. Red light may be used to activate the sebaceous glands in the deep layers of the skin, and blue light may be used to regulate the surface condition of the skin by activating the keratoses in the epidermis. For example, light with a wavelength of 630 nm to 670 nm has a penetration depth of 2.3 mm, and can be effective from fibroblasts to reticular dermis. In particular, light having the wavelength in the range of 620 nm to 670 nm may be used to help activate hair cells and promote hair growth.

For example, as illustrated in FIG. 5, a peak wavelength of emission light emitted from the light emitting module 100 may be in a range of 620 nm to 670 nm. A luminous intensity spectrum of the emission light may have a peak in the range of 620 nm to 670 nm. The luminous intensity spectrum of the emission light may have a maximum peak intensity in the range of 620 nm to 670 nm.

In addition, the luminous intensity spectrum of the emission light may have at least one peak in a range of 380 nm to 620 nm. Alternatively, the luminous intensity spectrum of the emission light may have at least one peak in the range of 380 nm to 620 nm. Alternatively, the luminous intensity spectrum of the emission light may have at least one peak in a range of 380 nm to 480 nm. Still alternatively, the luminous intensity spectrum of the emission light may have at least one peak in a range of 430 nm to 480 nm.

In addition, the luminous intensity spectrum of the emission light may have at least one valley in the range of 380 nm to 620 nm. Alternatively, the luminous intensity spectrum of the emission light may have at least one valley in the range of 380 nm to 480 nm.

In the luminous intensity spectrum of the emission light, a peak luminous intensity in the wavelength range of 380 nm to 480 nm may be 0.5 times or less of a peak luminous intensity in the wavelength range of 620 nm to 670 nm. According to an embodiment, in the luminous intensity spectrum of the emission light, the peak luminous intensity in the wavelength range of 380 nm to 480 nm may be 0.4 times or less of the peak luminous intensity in the wavelength range of 620 nm to 670 nm. Accordingly, the risk of skin damage that may be caused by light energy in a shorter wavelength region may be reduced by lowering the peak luminous intensity in the region of 380 nm to 480 nm, which is a relatively shorter wavelength than 620 nm to 670 nm.

When the peak luminous intensity in the wavelength range of 620 nm to 670 nm is referred to as a first peak luminous intensity and the peak luminous intensity in the wavelength range of 380 nm to 480 nm is referred to as a second peak luminous intensity, the luminous intensity spectrum of the emission light may have a third peak luminous intensity in a wavelength range of 480 nm to 620 nm, more particularly in a wavelength range of 530 nm to 620 nm that is smaller than the second peak luminous intensity. Using light in the wavelength region having the third peak luminous intensity may suppress fungus on the scalp and keep the scalp clean. The third peak luminous intensity may be less than 0.3 times of the first peak luminous intensity. In addition, the third peak luminous intensity may be less than 0.6 times of the second peak luminous intensity. Light having a wavelength range between 530 nm and 620 nm is in a region of high visual sensitivity, and thus may be efficient in that high brightness can be provided even with relatively low energy.

In this case, the light sources 120 and 130 may include a first light source 120 having the first peak luminous intensity in the wavelength range of 620 nm to 670 nm, and a second light source 130 having the second peak luminous intensity in a wavelength range of 380 nm to 620 nm.

The first light source 120 is configured to irradiate red light in the wavelength range of 620 nm to 670 nm, which is effective in promoting hair growth when irradiated to the scalp, and can be configured in various ways. The first light source 120 may be provided in a plurality.

In FIG. 5, A1 is a luminous intensity spectrum of emission light emitted from the first light source 120, and may be a first luminous intensity spectrum. The first luminous intensity spectrum A1 may have a single peak in a wavelength range of 380 nm to 730 nm. A peak wavelength of emission light of the first light source 120 may be in the range of 620 nm to 670 nm. The first luminous intensity spectrum may have at least one or more peaks in the wavelength range of 620 nm to 670 nm. A full width at half maximum at the peak wavelength of the first luminous intensity spectrum may be 20 nm or less.

Since the light emitting module 100 for vehicles is installed in the vehicle 10 and may irradiate light to the scalp side of the occupant 20, a time spent riding in the vehicle 10 may be utilized for scalp treatment or hair loss treatment. An output of the first light source 120 may be controlled in consideration of safety and risks such as side effects.

The second light source 130 is configured to irradiate light in the wavelength range of 380 nm to 620 nm, and can be configured in various ways. The second light source 130 may cause stimulation to an epidermal region of the human body by emitting blue light or UV light. The second light source 130 may be provided in a plurality.

In FIG. 5, A2 is a luminous intensity spectrum of emission light emitted from the second light source 130, and may be a second luminous intensity spectrum. The second luminous intensity spectrum A2 may be partially overlapped with the first luminous intensity spectrum A1. The second luminous intensity spectrum A2 may have multi peaks in the wavelength range of 380 nm to 730 nm. A maximum peak luminous intensity of the second luminous intensity spectrum A2 may be less than that of the first luminous intensity spectrum A1. Accordingly, it is possible to increase an effectiveness of scalp treatment or hair loss treatment.

When the first light source 120 among the plurality of light sources 120 and 130 is turned on, the light emitting module 100 may emit emission light emitted from the first light source 120 to the outside. In this case, emission light may have the first luminous intensity spectrum A1.

When the second light source 130 among the plurality of light sources 120 and 130 is turned on, the light emitting module 100 may emit emission light emitted from the second light source 130 to the outside. In this case, emission light may have the second luminous intensity spectrum A2.

When both the first light source 120 and the second light source 130 are turned on, the light emitting module 100 may emit mixed light, which is a mixture of emission light emitted from the first light source 120 and emission light emitted from the second light source 130, to the outside. In this case, emission light may have a third luminous intensity spectrum A3 that is a sum of the first luminous intensity spectrum A1 and the second luminous intensity spectrum A2.

A first total luminous intensity by the first light source 120 may correspond to an entire area of the first luminous intensity spectrum A1 over the entire wavelength range. Likewise, a second total luminous intensity by the second light source 130 may correspond to an entire area of the second luminous intensity spectrum A2 for the entire wavelength. In this case, the second total luminous intensity may be greater than the first total luminous intensity. The second total luminous intensity may be three or more times of the first total luminous intensity. Accordingly, it is possible to provide visually comfortable colors to the occupant, and provide balanced light in natural light and color reproduction.

The third luminous intensity spectrum A3 may have a peak in the wavelength range of 380 nm to 620 nm. Alternatively, the third luminous intensity spectrum A3 may have a peak in a wavelength range of 380 nm to 530 nm. Still alternatively, the third luminous intensity spectrum A3 may have a peak in the wavelength range of 380 nm to 480 nm.

For example, the third luminous intensity spectrum A3 may have a first valley in a range of 460 nm to 500 nm. Accordingly, it is possible to distribute energy so that light in a required wavelength region is emitted, thereby reducing power loss.

In the third luminous intensity spectrum A3, a luminous intensity in the wavelength range of 380 nm to 480 nm may be 25% or less of a total luminous intensity. Herein, the total luminous intensity may mean an entire area of the third luminous intensity spectrum A3 for the entire wavelength. An entire wavelength range may be from 380 nm to 780 nm. For example, in the third luminous intensity spectrum A3, the luminous intensity in the wavelength range of 380 nm to 480 nm may be 20% or less of the total luminous intensity. Accordingly, it is efficient because it may provide high brightness even with low energy.

In addition, the third luminous intensity spectrum A3 may have a peak in the wavelength range of 620 nm to 670 nm. In the third luminous intensity spectrum A3, a luminous intensity in the wavelength range of 620 nm to 670 nm may be 35% or less of the total luminous intensity. For example, in the third luminous intensity spectrum A3, the luminous intensity in the wavelength range of 620 nm to 670 nm may be 30% or less of the total luminous intensity. Accordingly, it is possible to provide visually comfortable colors to the occupant, and provide balanced light in natural light and color reproduction. In the third luminous intensity spectrum A3, the luminous intensity in the wavelength range of 620 nm to 670 nm may be greater than the luminous intensity in the wavelength range of 380 nm to 480 nm. Accordingly, it is possible to effectively increase the therapeutic effect.

Light emitted from the second light source 130 may have multi peaks on the second luminous intensity spectrum A2, and for example, the second light source 130 may include a multi-peak light emitting diode. As another example, the second light source 130 may include a single light emitting diode and a wavelength converter that is excited by emission light emitted from the light emitting diode and emits excited light. In this case, the light emitting diode may emit blue light or UV light. The wavelength converter may include microparticles that are excited by blue light or UV light and emit green or yellow excited light. The microparticles may be phosphor particles, quantum dots, or organic dyes. For example, wavelength conversion particles that emit light having a peak wavelength in a green or yellow light band may include, without being limited thereto, at least one of quantum dots, LuAG series, YAG series, beta-SiAlON series, nitride series, silicate series, halophosphide series, or oxynitride series.

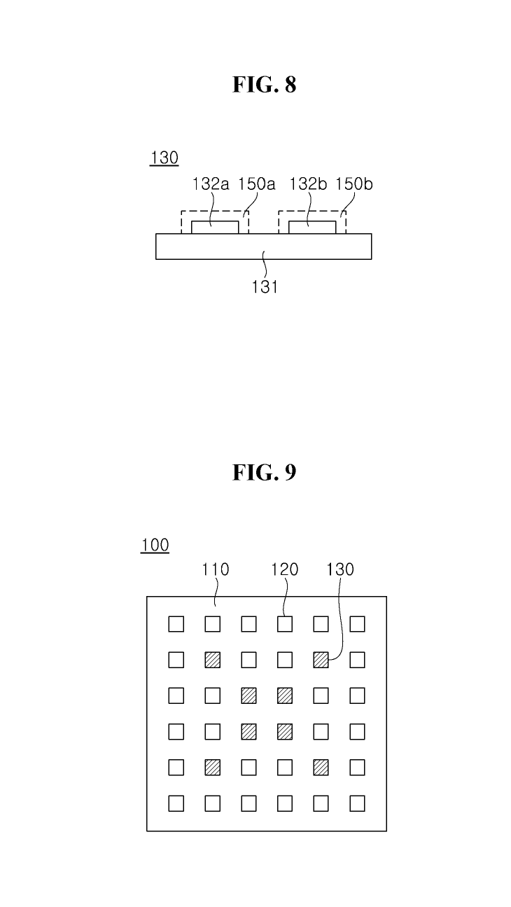

As another example, the second light source 130 may include, as illustrated in FIG. 8, first and second light emitting diodes 132a and 132b that emit light of different wavelengths from each other. The first and second light emitting diodes 132a and 132b may be directly disposed on the substrate 110 or may be disposed on the substrate 110 while being mounted on an additional base substrate 131. In an embodiment, the second light source 130 may further include at least one of a wavelength converter 150a, which covers the first light emitting diode 132a and excited by emission light of the first light emitting diode 132a, and a wavelength converter 150b, which covers the second light emitting diode 132b and excited by emission light of the second light emitting diode 132b. The wavelength converters 150a and 150b may include at least one of microparticles emitting green excited light and microparticles emitting yellow excited light.

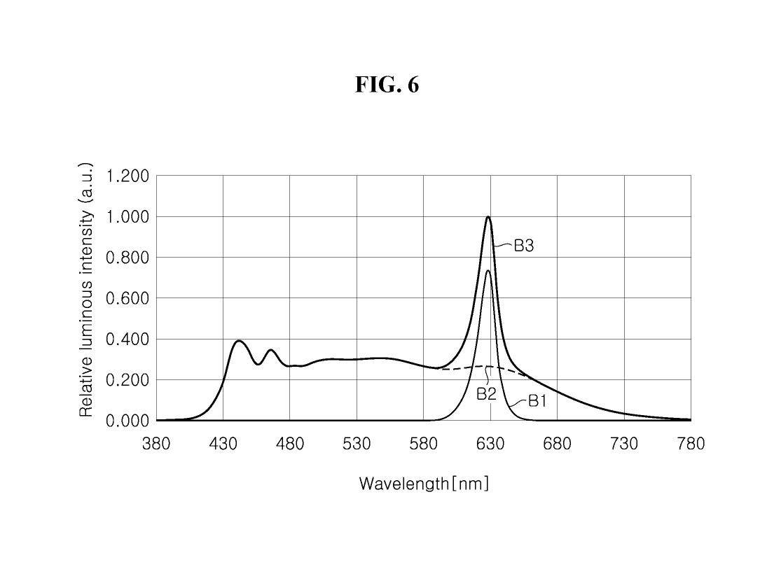

As still another example, as illustrated in FIG. 6, a peak wavelength of emission light emitted from the light emitting module 100 may be in a range of 580 nm to 680 nm. Alternatively, the peak wavelength of the emission light may be in a range of 600 nm to 670 nm. For example, the peak wavelength of emission light emitted from the light emitting module 100 may be in a range of 620 nm to 670 nm. More particularly, the peak wavelength of the emission light may be in a range of 620 nm to 650nm.

A luminous intensity spectrum of the emission light may have a peak in the range of 580 nm to 680 nm. Alternatively, the luminous intensity spectrum of the emission light may have a peak in the range of 600 nm to 670 nm. For example, the luminous intensity spectrum of the emission light may have a peak in the range of 620 nm to 670 nm. More particularly, the luminous intensity spectrum of the emission light may have a maximum peak intensity in the range of 620 nm to 650 nm. Accordingly, it is possible to effectively increase the therapeutic effect.

In addition, the luminous intensity spectrum of the emission light may have at least one peak in a range of 380 nm to 620 nm. Alternatively, the luminous intensity spectrum of the emission light may have one or more peaks in a range of 380 nm to 580 nm. Still alternatively, the luminous intensity spectrum of the emission light may have at least one peak in a range of 380 nm to 480 nm. Still alternatively, the luminous intensity spectrum of the emission light may have at least one peak in a range of 430 nm to 480 nm.

For example, the luminous intensity spectrum of the emission light may have multi peaks in the range of 430 nm to 480 nm. Accordingly, it is possible to enhance the therapeutic effect on a skin surface using one or more blue lights having different peak wavelengths from one another. The multi peaks may have a peak luminous intensity different from one another. A difference in peak luminous intensity may be less than 10%. Accordingly, it is possible to improve light uniformity. In addition, the luminous intensity spectrum of the emission light may have at least one valley in the range of 380 nm to 620 nm. Alternatively, the luminous intensity spectrum of the emission light may have at least one valley in the range of 380 nm to 480 nm. In this manner, light may be focused on a required phototherapy wavelength, thereby increasing light efficiency and enhancing the therapeutic effect.

In the luminous intensity spectrum of the emission light, a peak luminous intensity in the wavelength range of 380 nm to 480 nm may be 0.5 times or less of a peak luminous intensity in the wavelength range of 580 nm to 680 nm. More particularly, in the luminous intensity spectrum of the emission light, the peak luminous intensity in the wavelength range of 380 nm to 480 nm may be 0.4 times or less of a peak luminous intensity in the wavelength range of 580 nm to 680 nm. In this manner, light may be focused on the required phototherapy wavelength, thereby increasing the light efficiency and enhancing the therapeutic effect.

When a peak luminous intensity in the wavelength range of 620 nm to 670 nm is referred to as a first peak luminous intensity and a peak luminous intensity in the wavelength range of 380 nm to 480 nm is referred to as a second peak luminous intensity, the luminous intensity spectrum of the emission light may have a third peak luminous intensity in a wavelength range of 480 nm to 620 nm that is smaller than the second peak luminous intensity. The third peak luminous intensity may be less than 0.4 times of the first peak luminous intensity. In addition, the third peak luminous intensity may be less than 0.7 times of the second peak luminous intensity. Light having the wavelength range between 480 nm and 620 nm is in a region of high visual sensitivity, and thus may be efficient in that high brightness can be provided even with relatively low energy.

In this case, the light sources 120 and 130 may include a first light source 120 having the first peak luminous intensity in the wavelength range of 620 nm to 670 nm, and a second light source 130 having the second peak luminous intensity in the wavelength range of 380 nm to 480 nm. As described above, when using a plural number of light sources 120 and 130 having a different wavelength range peak luminous intensity from one another, a design difficulty of the light emitting module 100 may be reduced.

The first light source 120 may be configured to irradiate red light in the wavelength range of 580 nm to 680 nm, more particularly in 620 nm to 670 nm, which is effective in promoting hair growth when irradiated to the scalp, and can be configured in various ways. The first light source 120 may be provided in a plurality. In FIG. 6, B1 is a luminous intensity spectrum of emission light emitted from the first light source 120, and may be a first luminous intensity spectrum. A peak wavelength of emission light of the first light source 120 may be in the range of 620 nm to 670 nm. The luminous intensity spectrum of the emission light may have at least one or more peaks in the wavelength range of 620 nm to 670 nm. A full width at half maximum at the peak wavelength of the first luminous intensity spectrum may be 20 nm or less. Since the light emitting module 100 for vehicles is installed in the vehicle 10 and may irradiate light to the scalp side of the occupant 20, the time spent riding in the vehicle 10 may be utilized for scalp treatment or hair loss treatment. An output of the first light source 120 may be controlled in consideration of safety and risks such as side effects.

The second light source 130 is configured to irradiate light in the wavelength range of 380 nm to 620 nm, and can be configured in various ways. The second light source 130 may cause stimulation to the epidermal region of the human body by emitting blue light or UV light. The second light source 130 may be provided in a plurality. In FIG. 6, B2 is a luminous intensity spectrum of emission light emitted from the second light source 130, and may be a second luminous intensity spectrum. The second luminous intensity spectrum B2 may be partially overlapped with the first luminous intensity spectrum B1. The second luminous intensity spectrum B2 may have multi peaks in a wavelength range of 380 nm to 730 nm. In particular, the second luminous intensity spectrum B2 may have a maximum peak in a shorter blue wavelength region (430nm to 450nm) and may have a peak smaller than a maximum peak in a longer blue wavelength region (450nm to 480 nm). A maximum peak luminous intensity of the second luminous intensity spectrum B2 may be less than that of the first luminous intensity spectrum B1. Accordingly, light may be focused on a required phototherapy wavelength, thereby increasing light efficiency and enhancing the therapeutic effect.

When the first light source 120 among a plurality of light sources 120 and 130 is turned on, the light emitting module 100 may emit emission light emitted from the first light source 120 to the outside. In this case, emission light may have the first luminous intensity spectrum B1.

When the second light source 130 among the plurality of light sources 120 and 130 is turned on, the light emitting module 100 may emit emission light emitted from the second light source 130 to the outside. In this case, emission light may have the second luminous intensity spectrum B2.

When both the first light source 120 and the second light source 130 are turned on, the light emitting module 100 may emit mixed light, which is a mixture of emission light emitted from the first light source 120 and emission light emitted from the second light source 130, to the outside. In this case, emission light may have a third luminous intensity spectrum B3 that is a sum of the first luminous intensity spectrum B1 and the second luminous intensity spectrum B2.

A first total luminous intensity by the first light source 120 may correspond to an entire area of the first luminous intensity spectrum B1 for an entire wavelength. Likewise, a second total luminous intensity by the second light source 130 may correspond to an entire area of the second luminous intensity spectrum B2 for the entire wavelength. In this case, the second total luminous intensity may be greater than the first total luminous intensity. The second total luminous intensity may be three times or more, more particularly five times or more, of the first total luminous intensity.

The third luminous intensity spectrum B3 may have a peak in the wavelength range of 380 nm to 620 nm. Alternatively, the third luminous intensity spectrum B3 may have a peak in a wavelength range of 380 nm to 530 nm. Still alternatively, the third luminous intensity spectrum B3 may have a peak in the wavelength range of 380 nm to 480 nm.

For example, the third luminous intensity spectrum B3 may have a first valley between 430 nm and 480nm. Accordingly, light may be focused on the required phototherapy wavelength, thereby increasing the light efficiency and enhancing the therapeutic effect.

In the third luminous intensity spectrum B3, a luminous intensity in the wavelength range of 380 nm to 480 nm may be 25% or less of a total luminous intensity. Herein, the total luminous intensity may mean an entire area of the third luminous intensity spectrum B3 for the entire wavelength. An entire wavelength range may be from 380 nm to 780 nm. According to an embodiment, in the third luminous intensity spectrum B3, the luminous intensity in the wavelength range of 380nm to 480 nm may be 20% or less of the total luminous intensity. Accordingly, it is possible to minimize damage to the skin or eyes caused by blue light.

In addition, the third luminous intensity spectrum B3 may have a peak in the wavelength range of 620 nm to 670 nm. In the third luminous intensity spectrum B3, a luminous intensity in the wavelength range of 620 nm to 670 nm may be 25% or less of the total luminous intensity. According to an embodiment, in the third luminous intensity spectrum B3, the luminous intensity in the wavelength range of 620 nm to 670 nm may be 20% or less of the total luminous intensity. Accordingly, it is possible to provide visually comfortable colors to the occupant, and provide balanced light in natural light and color reproduction. In the third luminous intensity spectrum B3, the luminous intensity in the wavelength range of 620 nm to 670 nm may be less than the luminous intensity in the wavelength range of 380 nm to 480 nm. Accordingly, light may be focused on the required phototherapy wavelength, thereby increasing the light efficiency and enhancing the therapeutic effect.

Meanwhile, light emitted from the second light source 130 may have multi peaks on the second luminous intensity spectrum B2, and for example, the second light source 130 may include a multi-peak light emitting diode. As another example, the second light source 130 may include a single light emitting diode and a wavelength converter that is excited by emission light emitted from the light emitting diode and emits excited light. In this case, the light emitting diode may emit blue light or UV light. The wavelength converter may include microparticles that are excited by blue light or UV light and emit green or yellow excited light. The microparticles may be one of phosphor particles, quantum dots, or organic dyes. For example, wavelength conversion particles that emit light having a peak wavelength in a green or yellow light band may include, without being limited thereto, at least one of quantum dots, LuAG series, YAG series, beta-SiAlON series, nitride series, silicate series, halophosphide series, or oxynitride series. In addition, the microparticles may include red wavelength conversion particles that emit light having a peak wavelength in a red light band. The red wavelength conversion particle may include, without being limited thereto, at least one of quantum dots, nitride series such as CASN, CASON, and SCASN, silicate series, sulfide series, and fluoride series.

As another example, the second light source 130 may include, as illustrated in FIG. 8, first and second light emitting diodes 132a and 132b that emit light of different wavelengths from each other. The first and second light emitting diodes 132a and 132b may be directly disposed on the substrate 110 or may be disposed on the substrate 110 while being mounted on an additional base substrate 131. In an embodiment, the second light source 130 may further include at least one of a wavelength converter 150a, which covers the first light emitting diode 132a and excited by emission light of the first light emitting diode 132a, and a wavelength converter 150b, which covers the second light emitting diode 132b and excited by emission light of the second light emitting diode 132b. The wavelength converters 150a and 150b may include at least one of microparticles that emit green excited light and microparticles that emit yellow excited light.

For example, the first light emitting diode 132a may be a blue light emitting diode that emits blue light, and the second light emitting diode 132b may be a blue light emitting diode that emits blue light having a wavelength longer than that of the first light emitting diode 132a.

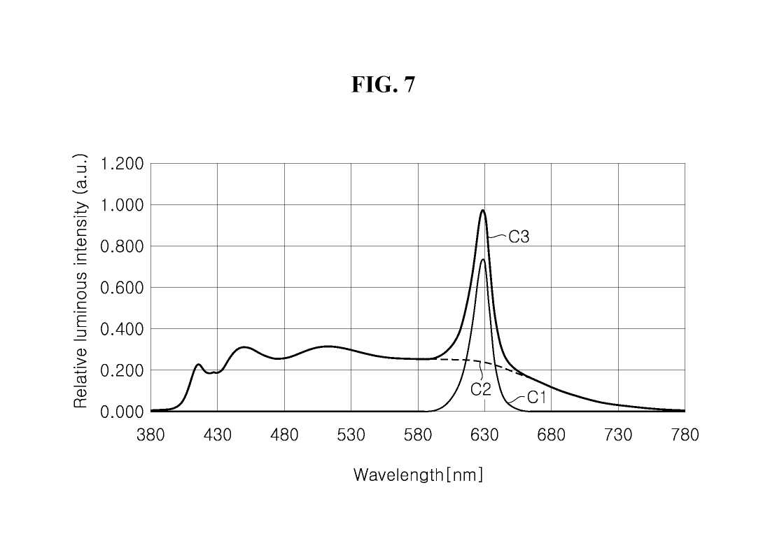

As another example, as illustrated in FIG. 7, a peak wavelength of emission light emitted from the light emitting module 100 may be in a range of 580 nm to 680 nm. Alternatively, the peak wavelength of the emission light may be in a range of 600 nm to 670 nm. In an embodiment, the peak wavelength of emission light emitted from the light emitting module 100 may be in a range of 620 nm to 670 nm. According to another embodiment, the peak wavelength of the emission light may be in a range of 620 nm to 650 nm.

A luminous intensity spectrum of the emission light may have a peak in a range of 580 nm to 680 nm. Alternatively, the luminous intensity spectrum of the emission light may have a peak in the range of 600 nm to 670 nm. In an embodiment, the luminous intensity spectrum of the emission light may have a peak in the range of 620 nm to 670 nm. According to another embodiment, the luminous intensity spectrum of the emission light may have a maximum peak intensity in the range of 620 nm to 650 nm. Accordingly, it is possible to effectively increase the therapeutic effect.

In addition, the luminous intensity spectrum of the emission light may have at least one peak in a range of 380 nm to 620 nm. Alternatively, the luminous intensity spectrum of the emission light may have at least one peak in a range of 380 nm to 580 nm. Still alternatively, the luminous intensity spectrum of the emission light may have at least one peak in a range of 380 nm to 480 nm. Still alternatively, the luminous intensity spectrum of the emission light may have at least one peak in a range of 430 nm to 480 nm.

According to an embodiment, the luminous intensity spectrum of the emission light may have multi peaks in the range of 380 nm to 480 nm. Accordingly, it is possible to enhance the therapeutic effect on the skin surface using one or more blue lights having different peak wavelengths from one another. The multi peaks may have a peak luminous intensity different from one another. A difference in peak luminous intensity may be less than 10%. Accordingly, it is possible to improve the light uniformity. In addition, the luminous intensity spectrum of the emission light may have at least one valley in the range of 380 nm to 620 nm. Alternatively, the luminous intensity spectrum of the emission light may have at least one valley in the range of 380 nm to 480 nm. Accordingly, light may be focused on the required phototherapy wavelength, thereby increasing the light efficiency and enhancing the therapeutic effect.

In the luminous intensity spectrum of the emission light, a peak luminous intensity in the wavelength range of 380 nm to 480 nm may be 0.5 times or less of a peak luminous intensity in the wavelength range of 580 nm to 680 nm.

According to an embodiment, in the luminous intensity spectrum of the emission light, the peak luminous intensity in the wavelength range of 380 nm to 480 nm may be 0.4 times or less of the peak luminous intensity in the wavelength range of 580 nm to 680 nm. According to another embodiment, in the luminous intensity spectrum of the emission light, the peak luminous intensity in the wavelength range of 380 nm to 480 nm may be 0.35 times or less of the peak luminous intensity in the wavelength range of 580 nm to 680 nm. Accordingly, light may be focused on the required phototherapy wavelength, thereby increasing the light efficiency and enhancing the therapeutic effect.

When a peak luminous intensity in the wavelength range of 620 nm to 670 nm is referred to as a first peak luminous intensity, and the peak luminous intensity in the wavelength range of 380 nm to 480 nm is referred to as a second peak luminous intensity, the luminous intensity spectrum of the emission light may have a third peak luminous intensity greater than or equal to the second peak luminous intensity in a wavelength range of 480 nm to 620 nm. The third peak luminous intensity may be less than 0.4 times of that of the first peak. Light between 480 nm and 620 nm may be in a region of high visual sensitivity, and thus may be efficient in that high brightness can be provided even with relatively low energy.

In this case, the light sources 120 and 130 may include a first light source 120 having the first peak luminous intensity in the wavelength range of 620 nm to 670 nm, and a second light source 130 having the second peak luminous intensity in the wavelength range of 380 nm to 480 nm.

The first light source 120 is configured to irradiate red light in the wavelength range of 580 nm to 680 nm or 620 nm to 670 nm, which is effective in promoting hair growth when irradiated to the scalp, and can be configured in various ways. The first light source 120 may be provided in a plurality. In FIG. 7, C1 is a luminous intensity spectrum of emission light emitted from the first light source 120, and may be a first luminous intensity spectrum. A peak wavelength of emission light of the first light source 120 may be in the range of 620 nm to 670 nm. The luminous intensity spectrum of the emission light may have at least one or more peaks in the wavelength range of 620 nm to 670 nm. A full width at half maximum of the emission light may be 20 nm or less. Since the light emitting module 100 for vehicles is installed in the vehicle 10 and may irradiate light to the scalp side of the occupant 20, the time spent riding in the vehicle 10 may be utilized for scalp treatment or hair loss treatment. An output of the first light source 120 may be controlled in consideration of safety and risks such as side effects.

The second light source 130 is configured to irradiate light in the wavelength range of 380 nm to 620 nm, and can be configured in various ways. The second light source 130 may cause stimulation to the epidermal region of the human body by emitting blue light or UV light. The second light source 130 may be provided in a plurality. In FIG. 7, C2 is a luminous intensity spectrum of emission light emitted from the second light source 130, and may be a second luminous intensity spectrum. The second luminous intensity spectrum C2 may be overlapped with the first luminous intensity spectrum C1. The second luminous intensity spectrum C2 may have multi peaks in a wavelength range of 380 nm to 730 nm. In particular, the second luminous intensity spectrum C2 may have peaks in a UV wavelength region (380 nm to 400 nm) and a blue wavelength region (430 nm to 450 nm). A peak in the blue wavelength region (430 nm to 450 nm) may be greater than a peak in the UV wavelength region (380 nm to 400 nm). In addition, the second luminous intensity spectrum C2 may have a peak in a green wavelength region (480 nm to 530 nm) that is smaller than or equal to that in the blue wavelength region (430 nm to 450 nm). A maximum peak luminous intensity of the second luminous intensity spectrum C2 may be less than that of the first luminous intensity spectrum C1. Accordingly, light may be focused on the required phototherapy wavelength, thereby increasing the light efficiency and enhancing the therapeutic effect.

When the first light source 120 among a plurality of light sources 120 and 130 is turned on, the light emitting module 100 may emit emission light emitted from the first light source 120 to the outside. In this case, emission light may have the first luminous intensity spectrum C1.

When the second light source 130 among the plurality of light sources 120 and 130 is turned on, the light emitting module 100 may emit light emitted from the second light source 130 to the outside. In this case, emission light may have the second luminous intensity spectrum C2.

When both the first light source 120 and the second light source 130 are turned on, the light emitting module 100 may emit mixed light, which is a mixture of emission light emitted from the first light source 120 and emission light emitted from the second light source 130, to the outside. In this case, emission light may have a third luminous intensity spectrum C3 that is a sum of the first luminous intensity spectrum C1 and the second luminous intensity spectrum C2.

A first total luminous intensity by the first light source 120 may correspond to an entire area of the first luminous intensity spectrum C1 for an entire wavelength. Likewise, a second total luminous intensity by the second light source 130 may correspond to an entire area of the second luminous intensity spectrum C2 for the entire wavelength. In this case, the second total luminous intensity may be greater than the first total luminous intensity. The second total luminous intensity may be three times or more, more particularly, five times or more, of the first total luminous intensity. Accordingly, it is possible to provide visually comfortable colors to the occupant, and provide balanced light in natural light and color reproduction.

The third luminous intensity spectrum C3 may have a peak in the wavelength range of 380 nm to 480 nm. Alternatively, the third luminous intensity spectrum C3 may have a peak in a wavelength range of 380 nm to 530 nm. Still alternatively, the third luminous intensity spectrum C3 may have a peak in the wavelength range of 380 nm to 480 nm.

For example, the third luminous intensity spectrum C3 may have a first valley between 380 nm and 450 nm. Accordingly, light may be focused on the required phototherapy wavelength, thereby increasing the light efficiency and enhancing the therapeutic effect.

In the third luminous intensity spectrum C3, a luminous intensity in the wavelength range of 380 nm to 480 nm may be 25% or less of a total luminous intensity. Herein, the total luminous intensity may mean an entire area of the third luminous intensity spectrum C3 for the entire wavelength. An entire wavelength range may be from 380 nm to 780 nm. In an embodiment, in the third luminous intensity spectrum C3, the luminous intensity in the wavelength range of 380 nm to 480 nm may be 22% or less of the total luminous intensity. Accordingly, a therapeutic effect on the skin may be obtained without damaging eyes.

In addition, the third luminous intensity spectrum C3 may have a peak in the wavelength range of 620 nm to 670 nm. In the third luminous intensity spectrum C3, a luminous intensity in the wavelength range of 620 nm to 670 nm may be 25% or less of the total luminous intensity. In an embodiment, in the third luminous intensity spectrum C3, the luminous intensity in the wavelength range of 620 nm to 670 nm may be 20% or less of the total luminous intensity. Accordingly, it is possible to provide visually comfortable colors to the occupant, and provide balanced light in natural light and color reproduction. In the third luminous intensity spectrum C3, the luminous intensity in the wavelength range of 620 nm to 670 nm may be less than the luminous intensity in the wavelength range of 380 nm to 480 nm. Accordingly, light may be focused on the required phototherapy wavelength, thereby increasing the light efficiency and enhancing the therapeutic effect.

Light emitted from the second light source 130 may have multi peaks on the second luminous intensity spectrum C2, and for example, the second light source 130 may include a multi-peak light emitting diode. As another example, the second light source 130 may include a single light emitting diode and a wavelength converter that is excited by emission light emitted from the light emitting diode and emits excited light. In this case, the light emitting diode may emit blue light or UV light. The wavelength converter may include microparticles that are excited by blue light or UV light and emit green or yellow excited light. The microparticles may be one of phosphor particles, quantum dots, or organic dyes. For example, wavelength conversion particles that emit light having a peak wavelength in a green or yellow light band may include, without being limited thereto, at least one of quantum dots, LuAG series, YAG series, beta-SiAlON series, nitride series, silicate series, halophosphide series, or oxynitride series. In addition, the microparticles may include red wavelength conversion particles that emit light having a peak wavelength in a red light band. The red wavelength conversion particle may include, without being limited thereto, at least one of quantum dots, nitride series such as CASN, CASON, and SCASN, silicate series, sulfide series, and fluoride series.

As another example, the second light source 130 may include, as illustrated in FIG. 8, first and second light emitting diodes 132a and 132b that emit light of different wavelengths from each other. The first and second light emitting diodes 132a and 132b may be directly disposed on the substrate 110 or may be disposed on the substrate 110 while being mounted on an additional base substrate 131. In an embodiment, the second light source 130 may further include at least one of a wavelength converter 150a covering the first light emitting diode 132a and excited by emission light of the first light emitting diode 132a and a wavelength converter 150b covering the second light emitting diode 132b and excited by emission light of the second light emitting diode 132a. The wavelength converters 150a and 150b may include at least one of microparticles emitting green excited light and microparticles emitting yellow excited light.

For example, the first light emitting diode 132a may be a UV light emitting diode that emits UV light, and the second light emitting diode 132b may be a blue light emitting diode that emits blue light.

Meanwhile, the plurality of light sources 120 and 130 may be disposed in various shapes or patterns on the substrate 110. For example, as illustrated in FIG. 9, the plurality of light sources 120 and 130 may be disposed in a matrix form having rows and columns, but this is only exemplary and the inventive concepts are not limited thereto.

For example, the plurality of light sources 120 and 130 may emit light having a same peak wavelength. As another example, at least one of the plurality of light sources 120 and 130 may emit light having a peak wavelength different from other light sources 120 and 130.

A luminous intensity spectrum of emission light emitted from each of the light sources 120 and 130 may be the same. Alternatively, a luminous intensity spectrum of emission light emitted from at least one of the plurality of light sources 120 and 130 may be different from those of emission light emitted from the other light sources 120 and 130. The design difficulty may be reduced by using light emitting devices having different spectra in the plurality of light sources 120 and 130.

Emission light emitted from the light emitting module 100 may be mixed light, which is a mixture of emission light emitted from the plurality of light sources 120 and 130.

A number of the first light sources 120 among the plurality of light sources 120 and 130 may be smaller than that of the second light sources 130. The first light source 120 may be disposed in an inner region of the substrate 110 and the second light source 130 may be disposed in an outer region of the substrate 110. A type of an arrangement of the first light sources 120 and the second light sources 130 illustrated in FIG. 9 is merely exemplary, and the inventive concepts are not limited to a particular arrangement of the first light sources 120 and the second light sources 130.

Meanwhile, the luminous intensity spectrum of emission light emitted from either the first light source 120 or the second light source 130 may have a spectrum similar to sunlight. Accordingly, the second light source 130 may emit lighting similar to sunlight.

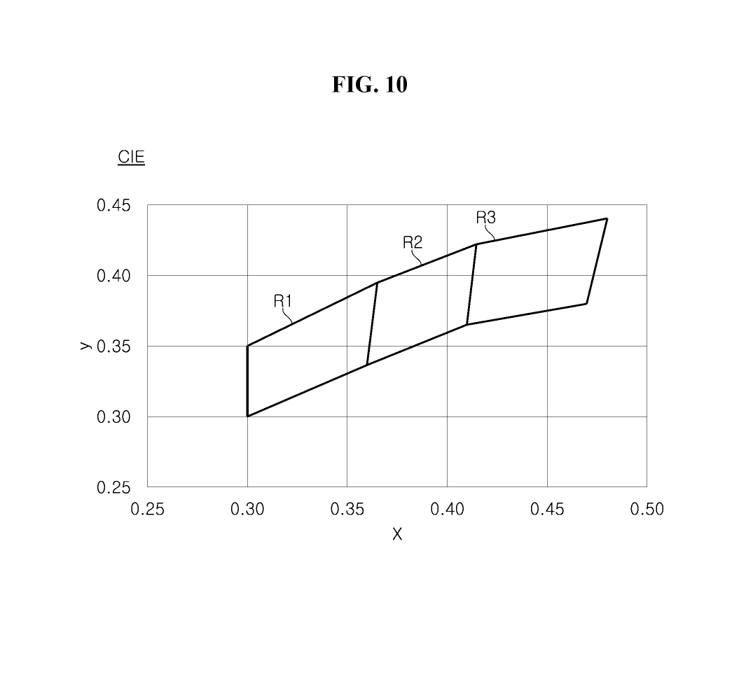

Referring to FIG. 10, one of the light sources 120 and 130 may have a color temperature similar to that of natural light.

For example, in a case of dawn, just before the sun rises, light is bluish, and as sunrise begins around 6 A.M., a reddish natural light is formed, which can have a color temperature of approximately 2000K to 3000K. A sunrise time zone when natural light is red has a relatively low color temperature, and may be positioned in a color coordinate region (R3 region in FIG. 10) bordered by (0.41, 0.365), (0.415, 0.422), (0.48, 0.44), and (0.47, 0.38) on CIE color coordinates.

After sunrise, around 12:00 P.M. when the sun is due south (that is, noon or meridian as seen from the Northern Hemisphere), a bluish natural light is formed, which can have a color temperature of approximately 5000K. A noon time zone when natural light is blue has a relatively high color temperature, and may be positioned in a color coordinate region (R1 region in FIG. 10) bordered by (0.3, 0.3), (0.3, 0.35), (0.365, 0.395), and (0.36, 0.336) on the CIE color coordinates.

When sunset begins around 6 P.M. after passing noon through midday, a reddish natural light forms again, which may have a color temperature of approximately 2000K to 3000K. A sunset time zone when natural light is red has a relatively low color temperature, and may be positioned in a color coordinate region (R3 region in FIG. 10) bordered by (0.41, 0.365), (0.415, 0.422), (0.48, 0.44), and (0.47, 0.38) on the CIE color coordinates.

Daylight between the noon time zone and the sunset time zone, that is, in a daylight time zone, may have a color temperature (for example, 4000K) between that of natural light of the noon time zone and that of natural light of the sunset time zone, and may be positioned in the color coordinate region (R2 region in FIG. 10) bordered by (0.36, 0.336), (0.365, 0.395), (0.415, 0.422), and (0.41, 0.365) on the CIE color coordinates.

Meanwhile, the light emitting module 100 for vehicles according to an embodiment of the invention may further include a controller that controls light quantity ratios of the plurality of light sources 120 and 130. The controller may independently control operations of the plurality of light sources 120 and 130.

More particularly, the controller may control the color temperature, a quantity of light, the luminous intensity spectrum, or others of light emitted by controlling the light quantity ratios of the first light source 120 and the second light source 130. According to the control of the controller, emission light emitted from the light emitting module 100 may be controlled. In a case that each of the light sources 120 and 130 includes a plurality of light emitting diode devices, the controller may also control light quantity ratios of the plurality of light emitting diode devices. For example, in a case that the second light source 130 includes the first light emitting diode 132a and the second light emitting diode 132b as illustrated in FIG. 8, the controller may implement lighting similar to natural light by controlling light quantity ratios of the first light emitting diode 132a and the second light emitting diode 132b at different time zones of day.

For example, the controller may drive only the first light source 120 at a ratio of 100% to irradiate emission light to the scalp to promote hair growth. As another example, the controller may drive only the second light source 130 at 100% ratio to emit light similar to natural light. As still another example, the controller may drive both the first light source 120 and the second light source 130 to emit light to promote hair growth and to emit light similar to natural light together. As yet another example, the controller may control light quantity ratios of a plurality of light emitting diodes of the second light source 130 to change the color temperature and spectrum by time zone from sunrise to sunset.

Embodiments of the invention may provide a light emitting module for vehicles that irradiates light toward an occupant riding in a vehicle.

Embodiments of the invention may provide a light emitting module for vehicles that irradiates light having a wavelength range associated with promoting hair growth to a scalp of an occupant riding in a vehicle.

Embodiments of the invention may provide a light emitting module with improved reliability.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A light emitting module for vehicles, comprising:
a substrate and a plurality of light sources disposed on the substrate,
wherein a peak wavelength of emission light emitted from at least one of the plurality of light sources is in a range of 620 nm to 670 nm.

2. The light emitting module for vehicles of claim 1, wherein the light emitting module is installed on an upper side of a seat in a vehicle.

3. The light emitting module for vehicles of claim 1, wherein a luminous intensity spectrum of emission light emitted from at least one of the plurality of light sources is different from that of emission light emitted from another one of the plurality of light sources.

4. The light emitting module for vehicles of claim 1, wherein a luminous intensity spectrum of emission light emitted from the light emitting module has at least one peak in a wavelength range of 380 nm to 480 nm.

5. The light emitting module for vehicles of claim 1, wherein a luminous intensity spectrum of emission light emitted from the light emitting module has at least one valley in a wavelength range of 380 nm to 480 nm.

6. The light emitting module for vehicles of claim 1, wherein, in a luminous intensity spectrum of emission light emitted from the light emitting module, a peak luminous intensity in a wavelength range of 380 nm to 480 nm is 0.4 times or less of a peak luminous intensity in the wavelength range of 620 nm to 670 nm.

7. The light emitting module for vehicles of claim 1, wherein, in a luminous intensity spectrum of emission light emitted from the light emitting module, a luminous intensity in a wavelength range of 380 nm to 480 nm is 25% or less of a total luminous intensity.

8. The light emitting module for vehicles of claim 1, wherein, in a luminous intensity spectrum of emission light emitted from the light emitting module, a luminous intensity in a wavelength range of 620 nm to 670 nm is 20% or less of a total luminous intensity.

9. The light emitting module for vehicles of claim 1, wherein, in a luminous intensity spectrum of emission light emitted from the light emitting module, a luminous intensity in a wavelength range of 620 nm to 670 nm is less than a luminous intensity in the wavelength range of 380 nm to 480 nm.

10. The light emitting module for vehicles of claim 4, wherein a luminous intensity spectrum of emission light emitted from the light emitting module has at least one peak in a wavelength range of 480 nm to 620 nm.

11. The light emitting module for vehicles of claim 10, wherein a maximum peak luminous intensity in the wavelength range of 480 nm to 620 nm is less than a maximum peak luminous intensity in the wavelength range of 380 nm to 480 nm.

12. The light emitting module for vehicles of claim 1, wherein the plurality of light sources comprises a first light source having a peak luminous intensity in the range of 620 nm to 670 nm and a second light source having a peak luminous intensity in the range of 380 nm to 480 nm.

13. The light emitting module for vehicles of claim 12, wherein a total luminous intensity of emission light emitted from the second light source is greater than that of emission light emitted from the first light source.

14. The light emitting module for vehicles of claim 12, wherein the total luminous intensity of emission light emitted from the second light source is three times or more of that of emission light emitted from the first light source.

15. The light emitting module for vehicles of claim 12, wherein at least a portion of a luminous intensity spectrum of emission light emitted from the second light source overlaps with a luminous intensity spectrum of emission light emitted from the first light source.

16. A light emitting module, comprising:
a substrate and a plurality of light sources disposed on the substrate,
wherein the plurality of light sources include a first light source configured to emit light having a peak wavelength in a range of 620 nm to 670 nm and a second light source configured to emit light having a plurality of peak wavelengths in a wavelength range of 380 nm to 730 nm.

17. The light emitting module of claim 16, further comprising a lens for adjusting an optical path of emission light emitted from at least one of the plurality of the light sources.

18. The light emitting module of claim 17, wherein the lens includes curved regions having different curvatures for each region of a light exiting surface.

19. The light emitting module of claim 18, wherein the light exiting surface of the lens includes a first curved region forming a first light-irradiation area, and a second curved region forming a second light-irradiation area wider than the first light-irradiation area and having a radius of curvature larger than that of the first curved region.

20. The light emitting module of claim 16, wherein:
the second light source includes a plurality of light emitting diodes having a peak wavelength different from that of the first light source; and
the light emitting module further comprises a controller configured to control light quantity ratios of the plurality of light emitting diodes such that a luminous intensity spectrum of emission light emitted from the second light source is similar to that of sunlight.
